(19) United States
(12) Patent Application Publication
(10) Pub. No.: US 2014/0375155 A1
(43) Pub. Date: Dec. 25, 2014

(54) MOTOR GENERATOR FOR VEHICLE

(71) Applicants: KIA MOTORS CORPORATION, Seoul (KR); HYUNDAI MOTOR COMPANY, Seoul (KR)

(72) Inventors: Hyun KIM, Uiwang-si (KR); Jae Hyuk SUH, Yongin-si (KR); Sam Gyun KIM, Hwaseong-si (KR); Seung Woo HA, Suwon-si (KR)

(73) Assignees: KIA MOTORS CORPORATION, Seoul (KR); HYUNDAI MOTOR COMPANY, Seoul (KR)

(21) Appl. No.: 14/083,042

(22) Filed: Nov. 18, 2013

(30) Foreign Application Priority Data
Jun. 20, 2013 (KR) 10-2013-0070789

(51) Int. Cl. H02K 5/10; H02K 7/10

(52) U.S. Cl. CPC H02K 5/10; H02K 7/1008
USPC 310/59; 310/58; 310/75 R

(57) ABSTRACT

A motor generator for a vehicle includes a housing having a through hole along a central axis thereof, with a protrusion protruding outwards along a circumference of the through hole. A rotating shaft is disposed in the housing in such a way that a first end thereof is exposed outside through the through hole. A pulley is disposed outside the housing in such a way that the first end of the rotating shaft is inserted into and coupled to a central portion of the pulley. A rim of the pulley is surrounded by the protrusion and a central portion of the pulley passes through the through hole, so that a watertight flange having a larger diameter than the through hole is disposed in the housing.

### CROSS REFERENCE TO RELATED APPLICATION

This application claims under 35 U.S.C. §119(a) the benefit of Korean Patent Application No. 10-2013-0070789 filed on Jun. 20, 2013, the entire contents of which are incorporated herein by reference.

### TECHNICAL FIELD

The present disclosure relates to a motor generator for a vehicle having a device which prevents water from entering the motor generator and discharges condensation and water out from the motor generator.

### BACKGROUND

A generator and a starter motor of a vehicle are critical parts in terms of the vehicle start and power generation. Since the generator and the starter motor need to continuously operate until the end of the vehicle service life, their durability needs to be good. With the development of hybrid vehicles, a motor generator serving as both the starter motor and the generator has been used. Thereby, a single device functions as the two existing parts, so that durability becomes more important for engine room temperature and humidity.

Generally, a failure in the motor generator may be caused by dielectric breakdown due to condensation and damage to a bearing because of the penetration of water from the outside. The condensation occurs when high-temperature parts, such as core, coil, magnet, etc. in the motor generator suffer from a sudden change in temperature. Water components in a casing of the motor generator are condensed in internal parts, thus leading to dielectric breakdown. Further, penetration of external water occurs when water flows from the outside into the motor generator under a severe driving condition, such as rainy road, salt-water road, high-pressure washing operation, etc. When the introduced water is not discharged from and collected in the motor generator, dielectric breakdown may occur.

In order to solve the above-mentioned problems, an internal-pressure regulating member has been disposed in the motor generator. The internal-pressure regulating member permits the passage of air but does not permit the passage of water, so that condensation can be prevented. However, the dielectric breakdown cannot be avoided, because discharge of water is impossible once water has been introduced into the internal-pressure regulating member.

The foregoing is intended merely to aid in the understanding of the background of the present disclosure, and is not intended to mean that the present disclosure falls within the purview of the related art that is already known to those skilled in the art.

### SUMMARY

Accordingly, the present disclosure has been made keeping in mind the above problems occurring in the related art, and an object of the present disclosure provides a motor generator for a vehicle, in which a protrusion formed between a motor-generator housing and a pulley prevents inflow of water, a groove formed in an internal bearing allows moisture to be discharged, and a drainpipe formed on a lower end of the housing allows collected water to be rapidly discharged.

According to an exemplary embodiment of the present disclosure, a motor generator for a vehicle includes a housing having a through hole along a central axis thereof, with a protrusion protruding outwards along a circumference of the through hole. A rotating shaft is disposed in the housing in such a way that a first end thereof is exposed outside through the through hole. A pulley is disposed outside the housing in such a way that the first end of the rotating shaft is inserted into and coupled to a central portion of the pulley. A rim of the pulley is surrounded by the protrusion and a central portion of the pulley passes through the through hole, so that a watertight flange having a larger diameter than the through hole defined in the housing.

The protrusion may protrude to be higher than a gap between the pulley and the housing.

A front end bearing and a rear end bearing coupled to the rotating shaft may be disposed on a front end and a rear end in the housing, respectively with a support portion formed in the housing and disposed along an outer surface of each of the front end bearing and the rear end bearing.

An air passage groove may be formed on a rear-end-bearing side at a junction between the rear end bearing and the rotating shaft.

The housing may comprise a drainpipe on a lower end thereof, the drainpipe extending outwards from the housing in such a way that an inside of the drainpipe communicates with an inside of the housing.

The drainpipe may be made of a rubber material.

An outlet of the drainpipe may extend downwards.

The housing may comprise the drainpipe on a lower end thereof, and the air passage groove is additionally disposed.

As described above, the motor generator for a vehicle is advantageous in that both the air passage groove disposed on the bearing and a drain structure disposed outside the housing circulate the air smoothly in the housing, thus suppressing the occurrence of the condensation in the motor generator.

Further, the motor generator for a vehicle is advantageous in that the protrusion disposed outside the housing and the flange disposed on the pulley prevent the inflow of water from the outside, thus preventing damage caused by condensation in the motor generator as well as dielectric breakdown and damage by the bearing due to penetration of water from the outside.

### BRIEF DESCRIPTION OF THE DRAWINGS

The above and other objects, features and advantages of the present disclosure will be more clearly understood from the following detailed description taken in conjunction with the accompanying drawings.

FIG. 1 is a view showing a configuration of a motor generator for a vehicle according to an embodiment of the present disclosure

FIG. 2 is a view showing an air passage groove of the motor generator for a vehicle according to the embodiment of the present disclosure

FIG. 3 is a view showing a drainpipe of the motor generator for a vehicle according to the embodiment of the present disclosure.

### DETAILED DESCRIPTION

Hereinafter, a motor generator for a vehicle according to an exemplary embodiment of the present disclosure will be described with reference to the accompanying drawings.

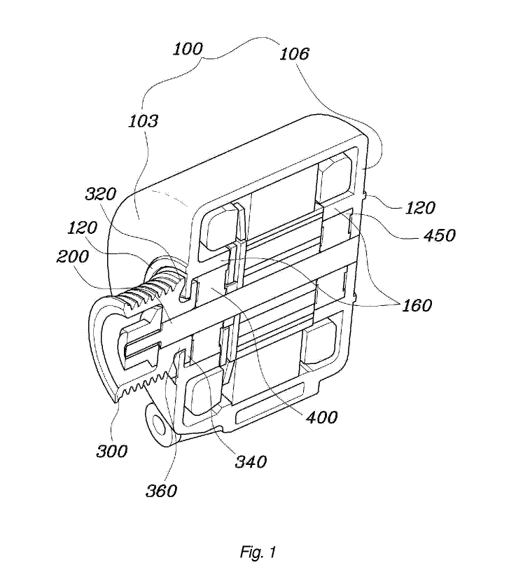

FIG. 1 is a view showing a configuration of a motor generator for a vehicle according to an embodiment of the present disclosure. The motor generator includes a housing 100 having a through hole along a central axis thereof, with a protrusion 120 protruding outwards along a circumference of the through hole. A rotating shaft 200 is disposed in the housing 100 in such a way that a first end thereof is exposed to the outside through the through hole. A pulley 300 is disposed outside the housing 100 in such a way that the first end of the rotating shaft 200 is inserted into and coupled to a central portion of the pulley 300. A rim 320 of the pulley 300 is surrounded by the protrusion 120, and a central portion of the pulley 300 passes through the through hole, so that a watertight flange 300 having a larger diameter than the through hole is disposed in the housing 100.

The protrusion 120 is formed on an outer portion of the housing 100 to define a step, thus effectively blocking water that flows from an upper or lower position of the motor generator to a center of the housing 100, and preventing the water from penetrating into the housing 100. The protrusion 120 may be disposed on each of a front face 103 and a rear face 106 of the housing 100 to prevent the inflow of water to the rear face, thus maximizing the effect of preventing the inflow of water.

Furthermore, the protrusion 120 may protrude to be higher than a gap between the pulley 300 and the housing 100. The protrusion 120 slightly covers the rim 320 of the pulley 300, thus effectively preventing the ingress of water flowing down the housing 100 as well as the ingress of water caused by spatter through a gap between the protrusion 120 and the pulley 300 at various angles.

A central portion 360 of the pulley 300 extends to the housing 100 to pass through the through hole, and the watertight flange 340 is disposed in the housing 100 so as to have a larger diameter than that of the through hole. Thus, water passing over the protrusion 120 is prevented from entering the housing 100. If there is no watertight flange 340 in the housing 100, water may flow from the outside through a gap between the through hole and the central portion 360 of the pulley 300 into the housing 100. However, the watertight flange 340 prevents water from flowing through the gap between the through hole and the central portion 360 of the pulley 300 into the housing 100, thus preventing damage, for example, a short circuit of a coil in the housing 100.

A front end bearing 400 and a rear end bearing 450 coupled to the rotating shaft 200 are disposed on a front end and a rear end in the housing 100, respectively, with a support portion 160 formed in the housing 100 and disposed along an outer surface of each of the front end bearing 400 and the rear end bearing 450.

Here, a front end in the housing 100 refers to a side of the front face 103 of the housing 100, that is, a side on which the pulley 300 is disposed, while a rear end refers to a side of the back face 106 of the housing 100.

To be more specific, the support portion 160 is integrally formed with the housing 100 in such a way so as to protrude inwards from each of the front face 103 and the rear face 106 of the housing 100 and formed along an outer surface of each of the front end bearing 400 and the rear end bearing 450. Thus, each of the front end bearing 400 and the rear end bearing 450 is precisely inserted into and secured to the support portion 160.

Each of the front end bearing 400 and the rear end bearing 450 inserted into the support portion 160 is coupled at a central portion thereof to the rotating shaft 200, thus rotating the rotating shaft 200 with respect to the housing 100.

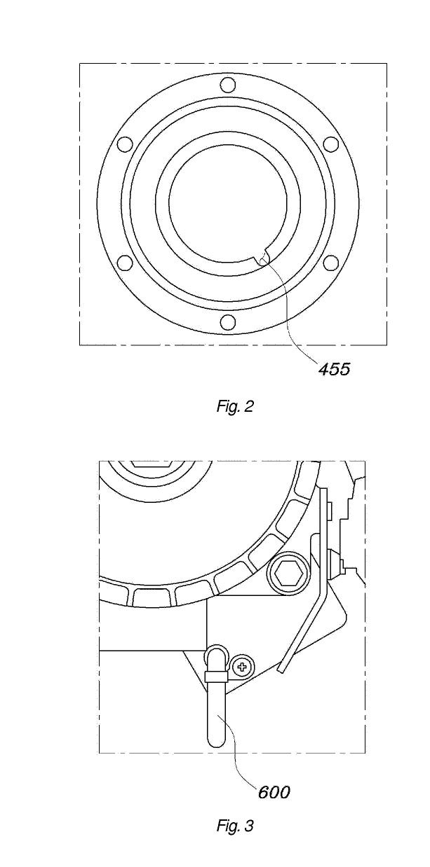

FIG. 2 is a view showing an air passage groove of the motor generator for a vehicle according to the embodiment of the present disclosure. An air passage groove 455 is formed on the side of the rear end bearing 450 at the junction between the rear end bearing 450 and the rotating shaft 200. The air passage groove 455 may comprise a single groove or a plurality of grooves, and is not limited to a semi-circular shape. Thus, the air passage groove 455 may be formed in various shapes and numbers.

The air passage groove 455 may also be formed on the side of the front end bearing 400. However, the air passage groove 455 may be formed only on the rear end bearing 450 because a relatively smaller amount of water is introduced into the rear face 106 of the housing 100 as compared to the front face 103. There may be no inflow of water into the housing 100 because of the protrusion 120 disposed on the rear face 106. Hence, the air passage groove 455 may be formed on the rear end bearing 450 to discharge the water from the housing 100.

In contrast, a relatively larger amount of water can penetrate into the front face 103 of the housing 100. In case of forming the air passage groove 455 on the side of the front end bearing 400, there is a possibility for water to flow into the front end bearing 400 or through the front end bearing 400 into the housing 100. Therefore, the air passage groove 455 may not be formed on the front end bearing 400.

FIG. 3 is a view showing a drainpipe 600 of the motor generator for a vehicle according to the embodiment of the present disclosure. The housing 100 includes the drainpipe 600 on a lower end thereof. The drainpipe 600 extends outwards from the housing 100 in such a way that an inside of the drainpipe 600 communicates with an inside of the housing 100. The drainpipe 600 is disposed on a high-voltage terminal block on the lower end of the housing 100, thus preventing a short circuit between terminals caused by water and further enhancing the durability and reliability of the motor generator.

The drainpipe 600 is preferably made of a rubber material. However, various materials such as resin or metal may be used for the drain pip 600, without being limited to the rubber material. If the drainpipe 600 is made of rubber, it is not affected by fatigue failure due to external shock or vibration of the motor generator itself, so that the drainpipe 600 can be used continuously without damage.

Further, an outlet of the drainpipe 600 may be bent downwards to discharge water from the motor generator, but water cannot flow from the outside through the drainpipe 600 into the motor generator. A downwardly bent or extending portion of the whole drainpipe 600 may be further lengthened for maximum effect.

Both the air passage groove 455 and the drainpipe 600 may be disposed to introduce the air into the air passage groove 455 and discharge to the drainpipe 600, thus smoothly circulating the air in the motor generator, or rapidly discharging the air from the motor generator through the air passage groove 455 and the drainpipe 600.

The motor generator for a vehicle described above is advantageous in that both the air passage groove 455 disposed on the rear end bearing 450 and the drainpipe 600 disposed outside the housing 100 smoothly circulate the air in the housing 100, thus suppressing the occurrence of the condensation in the motor generator.

Further, the motor generator for a vehicle is advantageous in that the protrusion 120 disposed outside the housing 100 and the watertight flange 340 disposed on the pulley 300 can prevent the inflow of water from the outside, thus preventing the damage caused by the condensation in the motor generator as well as the dielectric breakdown and the damage to the bearing caused by the penetration of water from the outside.

Although exemplary embodiments of the present disclosure have been disclosed for illustrative purposes, those skilled in the art will appreciate that various modifications, additions and substitutions are possible, without departing from the scope and spirit of the disclosure as disclosed in the accompanying claims.

What is claimed is:

1. A motor generator for a vehicle, comprising:
a housing having a through hole along a central axis thereof, with a protrusion protruding outwards along a circumference of the through hole;
a rotating shaft disposed in the housing in such a way that a first end thereof is exposed outside through the through hole; and
a pulley disposed outside the housing in such a way that the first end of the rotating shaft is inserted into and coupled to a central portion of the pulley, with a rim of the pulley being surrounded by the protrusion and a central portion of the pulley passing through the through hole, so that a watertight flange having a larger diameter than the through hole is disposed in the housing.

2. The motor generator as set forth in claim 1, wherein the protrusion protrudes to be higher than a gap between the pulley and the housing.

3. The motor generator as set forth in claim 1, wherein a front end bearing and a rear end bearing coupled to the rotating shaft are disposed on a front end and a rear end in the housing, respectively, with a support portion being formed in the housing in such a way so as to be disposed along an outer surface of each of the front end bearing and the rear end bearing.

4. The motor generator as set forth in claim 3, wherein an air passage groove is formed on a rear-end-bearing side, at a junction between the rear end bearing and the rotating shaft.

5. The motor generator as set forth in claim 1, wherein the housing comprises a drainpipe on a lower end thereof, the drainpipe extending outwards from the housing in such a way that an inside of the drainpipe communicates with an inside of the housing.

6. The motor generator as set forth in claim 5, wherein the drainpipe is made of a rubber material.

7. The motor generator as set forth in claim 5, wherein an outlet of the drainpipe extends downwards.

8. The motor generator as set forth in claim 4, wherein the housing comprises a drainpipe on a lower end thereof, the drainpipe extending outwards from the housing in such a way that an inside of the drainpipe communicates with an inside of the housing.

9. The motor generator as set forth in claim 5, wherein a front end bearing and a rear end bearing coupled to the rotating shaft are disposed on a front end and a rear end in the housing, respectively, with a support portion being formed in the housing in such a way so as to be disposed along an outer surface of each of the front end bearing and the rear end bearing; and
an air passage groove is formed on a rear-end-bearing side, at a junction between the rear end bearing and the rotating shaft.
